(19) United States
(12) Patent Application Publication
(10) Pub. No.: US 2015/0184363 A1
(43) Pub. Date: Jul. 2, 2015

(54) VIBRATION DEVICE FOR EXCAVATOR

(71) Applicants: Seong Chan LEE, (US); S & C CO., LTD., Incheon (KR)

(72) Inventors: Seong Chan Lee, Incheon (KR); Kyung Soon Seo, Incheon (KR)

(21) Appl. No.: 14/415,139

(22) PCT Filed: Jul. 17, 2013
(86) PCT No.: PCT/KR2013/006383

§ 371 Date: Jan. 16, 2015

(30) Foreign Application Priority Data
Jul. 17, 2012 (KR) 10-2012-0077598

(51) Int. Cl. E02F 9/20; F16H 19/02; E02F 5/32

(52) U.S. Cl. CPC E02F 9/202; E02F 5/326; F16H 19/02

(57) ABSTRACT

A vibration device for an excavator, including: an external body having an accommodation section inside thereof; a main vibration body being embedded in the external body and having a mounting bracket, formed at the bottom, for detaching and attaching tools and equipment; and a sliding apparatus being installed between one side surface of the main vibration body and the external body, wherein the main vibration body is a box-like body which consists of a plurality of supporting plates so as to have a space in the inside thereof; a reduction gear which is connected to a hydraulic motor and which rotates and operates by means of the drive of the hydraulic motor; a first eccentric member being engaged with the reduction gear and performs an eccentric operation; and a second eccentric member being engaged with the first eccentric member and performs an eccentric operation.

### FIELD OF THE INVENTION

The present invention relates to a vibration device for an excavator and, more particularly, to a vibration device for an excavator that can reduce the overall size and reduce a size and capacity of a motor by using a reduction gear and that can facilitate a sliding operation (or movements) of a main vibration body.

### BACKGROUND ART

Generally, an excavator refers to a type of heavy machinery that is used in diverse construction sites, such as construction and crushing (or destruction) of roads, bridges, and buildings, and, since the excavator demonstrates an outstanding force as compared to manpower, the excavator is advantageous in that working efficiency can be increased.

Such excavator is equipped with driving means, such as Caterpillars or wheels, at a lower portion of the vehicle body, so that self-powered driving can be performed, and the excavator is also equipped with a boom that is capable of performing bending, rotating, and elevating movements, so that the excavator can perform functions similar to the human arm, and diverse tools and equipments being required with respect to the nature of the operation are mounted to the end of the boom.

Recently, an exemplary excavator for enhancing its destructive force by adding a vibrating function at the end of the boom has been proposed.

The above-mentioned example is disclosed as a “Vibrating nipper”, which corresponds to a published Korean Patent Application No. 10-2009-0054513.

FIG. 1 illustrates a related art.

As shown in FIG. 1, as a general description of the related art nipper, a main body (13′) having a vibration space section (11′) and having a joining section (12′) on an upper portion of the vibration space section (11′) so as to be joined with a boom (200′) or an arm of a heavy machinery (or heavy equipment), a vibration unit (20′) being positioned in the vibration space and having a vibrator (30′) installed thereto, and multiple supporting means (40′) being supported by both side surfaces of a housing (21′) of the vibration unit (20′) and by the corresponding portion of the main body (13′), so as to allow the vibration unit (20′) to vibrate with respect to the main body (13′) are provided.

Additionally, the related art is also configured to include a vibration nipper blade (100′) being installed in the housing (21′) so as to extend downward, and a vibration-proof means (70′) being installed in the main body (13′) at an upper portion of the vibration space (11′), so as to distribute (or disperse) vibration occurring when the housing (21′) collides with the main body (13′) due to an elevation of the vibration unit (20′).

Therefore, in the related art, when the vibrator is operated, the vibration unit vibrates, and, accordingly, a vibration force is generated in the nipper performing vertical movements.

However, by having the driving motor installed directly to the vibrator (30′), since the size of the driving motor is required to be increased in accordance with an increase in the size of the main body (13′), the related art is disadvantageous in that as the overall size of the main body increases, the capacity of the driving motor increases as well.

### DETAILED DESCRIPTION OF THE INVENTION

### Technical Objects

As devised to resolve the above-described problems, an object of the present invention is to provide a vibration device for an excavator that can allow the overall size to become compact and that can reduce a capacity of a driving motor.

Another object of the present invention is to provide a vibration device for an excavator that can prevent a main vibration body from shaking in back-and-forth and left-to-right directions, when the main vibration body being installed inside of an external body vibrates.

Another object of the present invention is to provide a vibration device for an excavator that can more efficiently distribute frictional heat and vibration, which are generated when vibration occurs due to an elevating operation of the main vibration body being installed inside of the external body.

A further object of the present invention is to provide a vibration device for an excavator that can allow diverse tools and equipments, such as a bucket, a nipper, and a ground compaction plate, to be easily replaced and mounted on a mounting bracket provided on an upper end (or tip) of a boom.

### Technical Solutions

In order to achieve the above-described object, a vibration device for an excavator according to the present invention, wherein the vibration device includes an external body having an accommodation section inside thereof, a main vibration body being embedded in the external body and having a mounting bracket formed at the bottom for detaching and attaching tools and equipment, and a sliding apparatus being installed between one side surface of the main vibration body and the external body, wherein the main vibration body is a box-like body consisting of a plurality of supporting plates so as to have a space formed therein,

the vibration device for an excavator includes a reduction gear being connected to a hydraulic motor and being configured to rotate and operate by means of the drive of the hydraulic motor; a first eccentric member being engaged with the reduction gear and performing an eccentric operation; and a second eccentric member being engaged with the first eccentric member and performing an eccentric operation.

The reduction gear is equipped with a gear section of the reduction gear; the first eccentric member is equipped with a first rotating shaft, a first gear section, and a first eccentric weight; and the second eccentric member is equipped with a second rotating shaft, a second gear section, and a second eccentric weight, and

the gear section of the reduction gear is engaged with the first gear section, and the first gear section is engaged with the second gear section.

The first rotating shaft is supported by the supporting plates of the main vibration body due to a bearing, and the first gear section and the first eccentric weight are joined to the first rotating shaft, so as to be eccentric with respect to the first rotating shaft, and the second rotating shaft is supported by the supporting plates of the main vibration body due to a bearing, and the second gear section and the second eccentric weight are joined to the second rotating shaft, so as to be eccentric with respect to the second rotating shaft.

The sliding apparatus includes sliding panels being provided on inner walls of the external body each facing into one another; and multiple gliding sections on both side surfaces of the main vibration body, so as to contact the sliding panels.

The sliding apparatus includes multiple guard rails being installed on both side surfaces of the external body; and multiple rollers being securely fixed to the guard rails and being rollably installed to both side sections of the main vibration body.

At least two or more guard rails are installed on one side surface of the external body, and the multiple rollers are glidably positioned on the guard rails while the multiple rollers are installed to not be dislocated from the guard rails.

The sliding apparatus includes sliding panels being attached to upper portions or lower portions of both side surfaces of the main vibration body; and rolling members being provided between the sliding panels and the inner surfaces of the external body.

The rolling members correspond to cylindrical bars or multiple circular rollers.

In order to prevent the main vibration body from shaking back-and-forth and left-to-right inside the external body, a link member is rotatably installed between the external body and the main vibration member.

A stopper is installed at an upper portion of the sliding apparatus in order to restrict descending movements of the main vibration body when performing descending movements.

### Effects of the Invention

According to the present invention, the overall size of the vibration device may become compact, and the capacity of the driving motor may also be reduced.

According to the present invention, the frictional heat and vibration, which are generated when vibration occurs due to an elevating operation of the main vibration body being installed inside of the external body, may be more efficiently distributed.

According to the present invention, diverse tools and equipments, such as a bucket, a nipper, and a ground compaction plate, may be easily replaced and mounted on a mounting bracket provided on an upper end (or tip) of a boom.

### BRIEF DESCRIPTION OF THE DRAWINGS

FIG. 1 illustrates a related art.

FIG. 2 illustrates a vibration device for an excavator according to an exemplary embodiment of the present invention.

FIG. 3 illustrates a cross-sectional view showing a cross-section of the vibration device of FIG. 1.

FIG. 4 illustrates a vibration device for an excavator according to another exemplary embodiment of the present invention.

FIG. 5 illustrates a vibration device for an excavator according to yet another exemplary embodiment of the present invention.

FIG. 6 and FIG. 7 illustrate structures of coupling tools to a mounting bracket in the vibration device for an excavator according to the present invention.

### MODE FOR CARRYING OUT THE PRESENT INVENTION

Hereinafter, the vibration device for an excavator according to diverse exemplary embodiments of the present invention will be described in detail with reference to the accompanying drawings.

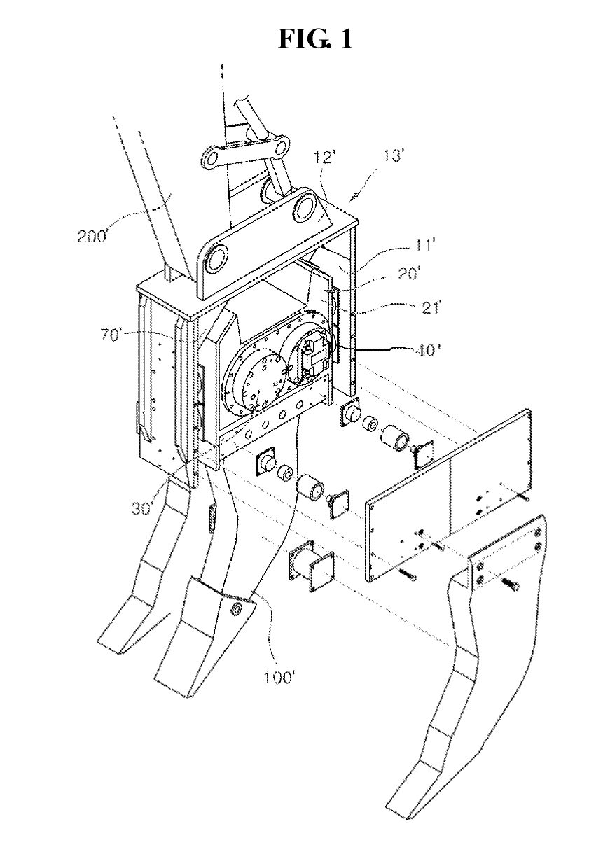

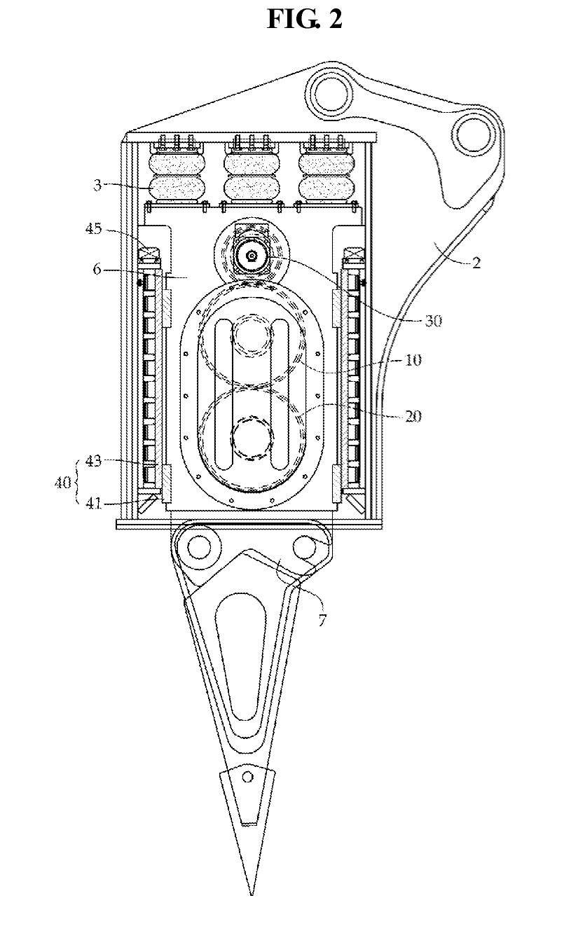

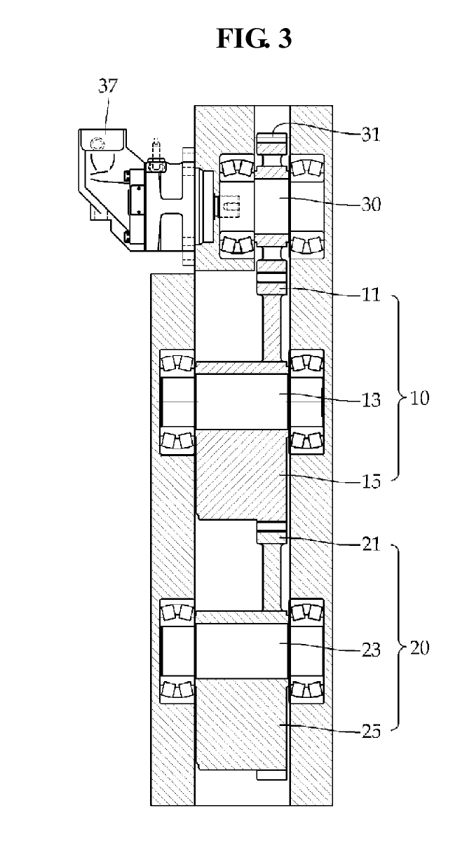

FIG. 2 illustrates a vibration device for an excavator according to an exemplary embodiment of the present invention, and FIG. 3 illustrates a cross-sectional view showing a cross-section of the vibration device of FIG. 1.

As shown in FIG. 2, the vibration device for an excavator according to exemplary embodiment of the present invention is provided with an external body (2), which has an accommodation section inside thereof, and a main vibration body (6), which is embedded in the external body (2), and which has a mounting bracket (7) formed at the bottom for detaching and attaching tools and equipment. A sliding apparatus (50) is provided between one side surface of the main vibration body (6) and the external body (2), wherein the sliding apparatus (50) allows friction and vibration, which are caused by an elevating operation of the main vibration body (6), to be reduced due to lubrication of a fluid, i.e., oil, which is filled in the sliding apparatus (50).

Additionally, multiple vibration-proof members (3) are installed in an empty space between an upper portion of the main vibration body (6) and the external body (2), and, herein, the vibration-proof member (3) may correspond to diverse types of shock absorbing members having elasticity, such as an elastic rubber, an air cushion, a shock absorber, and so on.

The sliding apparatus (50) is configured by being provided with sliding panels (43) on inner walls of the external body (2) each facing into one another, and also being provided with multiple gliding sections (41) on both side surfaces of the main vibration body (6). At this point, when the main vibration body (6) performs vertical (or up-and-down) elevating movements (or elevating operation), the multiple gliding sections (41) contact the sliding panels (43), thereby performing a function of reducing the friction and vibration occurring due to the sliding between the sliding panels (43).

The sliding panels (43) correspond to quadrangular boards being mounted on inner surfaces of the external body (2).

Accordingly, when the main vibration body (6) performs the elevating movements, an action respective to the sliding movement between the sliding panels (43) and the multiple gliding sections (41) may be performed, and, in order to reduce the frictional heat and noise occurring at this point, it will be preferable to deposit a lubricating oil, such as grease, on contacting surfaces between the sliding panels (43) and the multiple gliding sections (41).

As a box-like body consisting of a plurality of supporting plates (or multiple supporting plates), so as to have a space formed therein, the main vibration body (6) is inserted inside the external body (2), and the main vibration body (6) includes a first eccentric member (10), a second eccentric member (20), and a reduction gear (30) therein. At this point, the first eccentric member (10), the second eccentric member (20), and the reduction gear (30) are engaged with one another through gears so as to operate in interconnection with one another.

As shown in FIG. 3, the reduction gear (30) is provided with a gear section (31) and is coupled with a hydraulic motor (37) and performs rotating operations due to a driving of the hydraulic motor (37).

The first eccentric member (10) is provided with a first rotating shaft (13), a first gear section (11), and a first eccentric weight (15), and, herein, the first rotating shaft (13) is supported by the supporting plates of the main vibration body (6) due to a bearing. The first gear section (11) and the first eccentric weight (15) are joined to the first rotating shaft (13), so as to be eccentric with respect to the first rotating shaft (13).

The second eccentric member (20) is provided with a second rotating shaft (23), a second gear section (21), and a second eccentric weight (25), and, herein, the second rotating shaft (23) is supported by the supporting plates of the main vibration body (6) due to a bearing. The second gear section (21) and the second eccentric weight (25) are joined to the second rotating shaft (23), so as to be eccentric with respect to the second rotating shaft (23).

Therefore, the gear section (31) of the reduction gear is engaged with the first gear section (11) so as to operate in connection with the first gear section (11), and the first gear section (11) is engaged with the second gear section (21) so as to operate in connection with the second gear section (21). More specifically, the gear section (31) of the reduction gear rotates due to the drive of the hydraulic motor (37), and the first gear section (11) rotates due to such rotation, and, finally, as the second gear section (21), which is engaged with the first gear section (11), rotates, the main vibration body (6) may perform vertical (or up-and-down) elevating movements due to the eccentric operation of the first eccentric member (10) and the second eccentric member (20).

Since a stopper (45) is installed at an upper portion of the sliding apparatus 50, when the main vibration body (6) descends downward, the main vibration body (6) may be prevented from descending any further. It will be preferable for the stopper (45) to be configured of an elastic body in order to absorb noise or shock, when the stopper (45) comes into contact with the main vibration body (6).

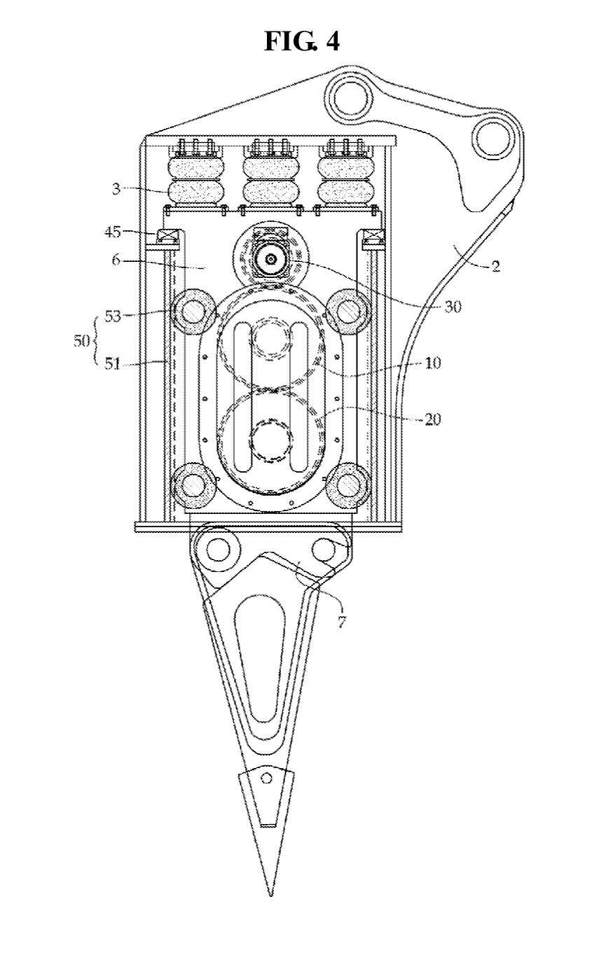

FIG. 4 illustrates a vibration device for an excavator according to another exemplary embodiment of the present invention.

The vibration device for an excavator according to another exemplary embodiment of the present invention, which is shown in FIG. 4, is identical or similar to the configuration of the vibration device for an excavator according to exemplary embodiment of the present invention, which is shown in FIG. 2, with the exception of having a different sliding apparatus configuration. Therefore, the same reference numerals will be used for the same configuration elements (or components), and detailed description of the same will be omitted.

As shown in FIG. 4, the sliding apparatus (50) of the vibration device for an excavator according to the other exemplary embodiment of the present invention is provided with multiple guard rails (51) being installed on both side surfaces of the external body (2) and multiple rollers (53) being securely fixed to the guard rails (51) and being rollably installed to both side sections of the main vibration body (6). The multiple rollers (53) may be installed by being supported by the main vibration body (6) due to the bearing.

Additionally, at least two or more guard rails (51) are installed on one side surface of the external body (2), and a slit-groove (not shown) may be formed on a center portion of each guard rail, so that the roller can be rollably positioned thereto, and, whenever required, the guard rails may be configured as protruded guard rails, such as railways of a train. In accordance with the shape of the guard rails, the rollers may be formed to have a convex shape or may be formed to have a concave shape.

As described above, while the multiple rollers (53) are glidably positioned on the guard rails (51), the multiple rollers (53) must also be installed to not be dislocated from the guard rails (51). Accordingly, due to the interconnected relation between the multiple rollers (53), which are installed on both side surfaces of the main vibration body (6), and the multiple guard rails (51), which are installed on the external body (2), back-and-forth and left-and-right shaking of the main vibration body may be limited.

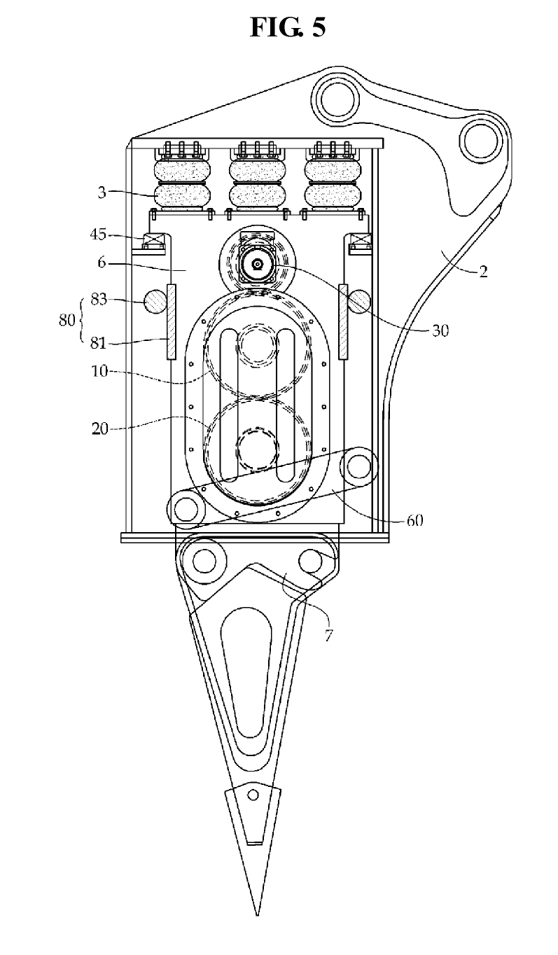

FIG. 5 illustrates a vibration device for an excavator according to yet another exemplary embodiment of the present invention.

The vibration device for an excavator according to another exemplary embodiment of the present invention, which is shown in FIG. 5, is identical or similar to the configuration of the vibration device for an excavator according to exemplary embodiment of the present invention, which is shown in FIG. 2, with the exception of having a different sliding apparatus configuration. Therefore, the same reference numerals will be used for the same configuration elements (or components), and detailed description of the same will be omitted.

As shown in FIG. 5, the sliding apparatus (80) of the vibration device for an excavator according to yet another exemplary embodiment of the present invention is provided with sliding panels (81) being attached to upper portions or lower portions of both side surfaces of the main vibration body (6), and rolling members (83) being provided between the sliding panels (81) and the inner surfaces of the external body (2). The rolling members (83) may correspond to cylindrical bar type rollers or multiple circular rollers, and the rolling members (83) are installed to be supported by the external body (2) due to a bearing (not shown).

Therefore, when the main vibration body (6) performs up-and-down (or vertical) elevating movements, the sliding panels (81) perform sliding movements with respect to the rolling members (83), and the rolling members (83) rotates at their fixed positions by means of the bearing, thereby allowing the sliding panels (81) to slide easily.

Additionally, a link member (60) may be rotatably installed between the external body (2) and the main vibration member (6). The link member (60) is provided in order to prevent the main vibration body (6) from shaking back-and-forth and left-to-right inside the external body (2).

In yet the other exemplary embodiment of the present invention, the sliding apparatus (80) is installed on an upper portion of the main vibration body (6), as shown in FIG. 5, and the link member (60) is installed at a lower portion of the main vibration body (6). However, whenever required, the sliding apparatus (80) may be installed on the lower portion of the main vibration body (6), and the link member (60) may be installed at the upper portion of the main vibration body (6).

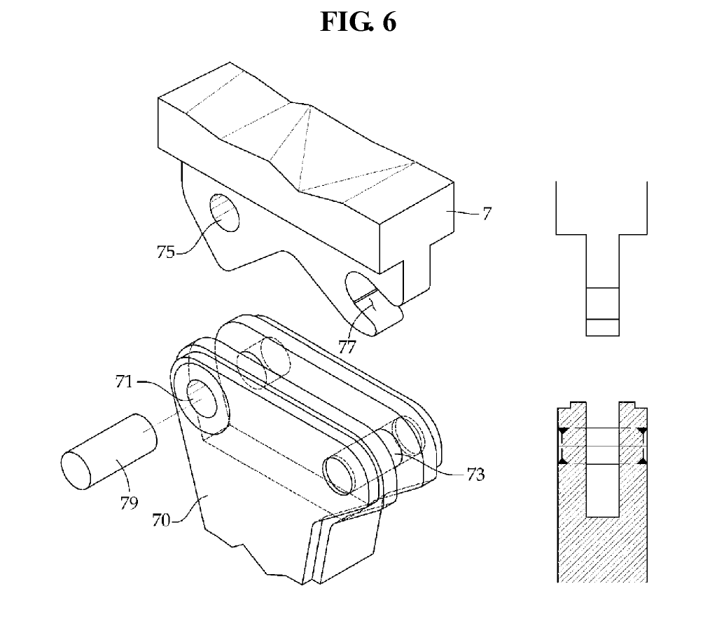

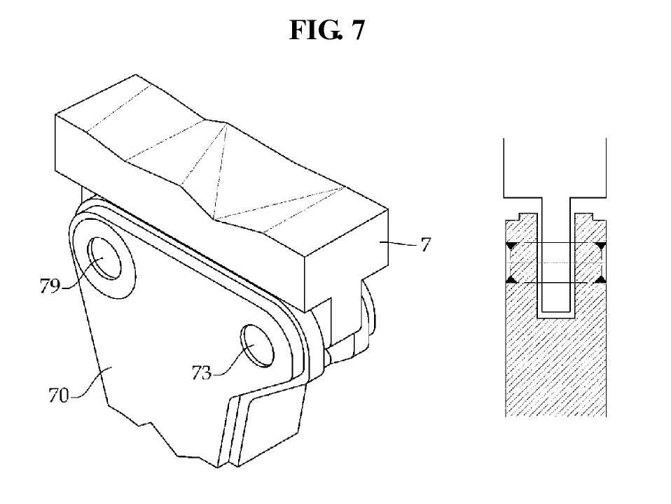

FIG. 6 and FIG. 7 illustrate structures of coupling tools to a mounting bracket in the vibration device for an excavator according to the present invention.

A structure for attaching tools and equipments to a mounting bracket (7) of the present invention may be fixed by a combination of a latch unit and a pin.

More specifically, for example, as shown in FIG. 6, in the vibration device for an excavator, the mounting bracket (7) is provided with a fixing hole (75) on one side and a fixing groove (77) on another side.

Accordingly, each of the diverse tools and equipments (70) is provided with a pin hole (71) corresponding to the fixing hole (75) of the mounting bracket (7) on one side and provided with a fixing shaft (73) corresponding to the fixing groove (77) of the mounting bracket (7) on another side.

Referring to such combination relation, the fixing shaft (73) of the tools and equipments (70) is first inserted and locked in the fixing groove (77) of the mounting bracket (7), and, while having the same center as the fixing hole (75), a pin (79) is inserted between the pin hole (71), thereby establishing a fixed combination.

Hereinafter, operations of the vibration device for an excavator according to the present invention will be described in detail.

As shown in FIG. 2 and FIG. 3, when the reduction gear (30) is operated by driving a hydraulic motor (37), the first gear section (11) that is engaged with the gear section (31) of the reduction gear rotates. At this point, with the rotation of the first eccentric weight (15), which rotates with respect to the same axis (or shaft) as the first gear section (11), the first eccentric weight (15) performs eccentric operation, thereby allowing the main vibration body (6) to perform vertical elevating movements.

Additionally, as the second gear section (21), which is engaged with the first gear section (11), also rotates, the second eccentric weight (25) rotates with respect to the same axis (or shaft) as the second gear section (21), and, accordingly, the main vibration body (6) performed vertical elevating movements with a greater force.

In performing such vertical elevating movements of the main vibration body (6), the sliding apparatus (50) is driven, and, as the multiple gliding sections (41) being installed on both surfaces of the main vibration body (6) performs sliding movements with respect to the fixed sliding member (40), friction and vibration may be reduced.

At this point, the vertical elevating movements of the main vibration body (6) may be restricted by the stopper (45).

1. In a vibration device for an excavator, the vibration device comprising an external body having an accommodation section inside thereof, a main vibration body being embedded in the external body and having a mounting bracket formed at the bottom for detaching and attaching tools and equipment, and a sliding apparatus being installed between one side surface of the main vibration body and the external body, wherein the main vibration body is a box-like body consisting of a plurality of supporting plates so as to have a space formed therein, the vibration device for an excavator comprises:
a reduction gear being connected to a hydraulic motor and being configured to rotate and operate by means of the drive of the hydraulic motor;
a first eccentric member being engaged with the reduction gear and performing an eccentric operation; and
a second eccentric member being engaged with the first eccentric member and performing an eccentric operation.

2. The vibration device of claim 1, wherein the reduction gear is equipped with a gear section of the reduction gear; wherein the first eccentric member is equipped with a first rotating shaft, a first gear section, and a first eccentric weight; and wherein the second eccentric member is equipped with a second rotating shaft, a second gear section, and a second eccentric weight, and
wherein the gear section of the reduction gear is engaged with the first gear section, and wherein the first gear section is engaged with the second gear section.

3. The vibration device of claim 2, wherein the first rotating shaft is supported by the supporting plates of the main vibration body due to a bearing, and wherein the first gear section and the first eccentric weight are joined to the first rotating shaft, so as to be eccentric with respect to the first rotating shaft, and
wherein the second rotating shaft is supported by the supporting plates of the main vibration body due to a bearing, and wherein the second gear section and the second eccentric weight are joined to the second rotating shaft, so as to be eccentric with respect to the second rotating shaft.

4. The vibration device of claim 1, wherein the sliding apparatus comprises:
sliding panels being provided on inner walls of the external body each facing into one another; and
multiple gliding sections on both side surfaces of the main vibration body, so as to contact the sliding panels.

5. The vibration device of claim 1, wherein the sliding apparatus comprises:
multiple guard rails being installed on both side surfaces of the external body; and
multiple rollers being securely fixed to the guard rails and being rollably installed to both side sections of the main vibration body.

6. The vibration device of claim 5, wherein at least two or more guard rails are installed on one side surface of the external body, and wherein the multiple rollers are glidably positioned on the guard rails while the multiple rollers are installed to not be dislocated from the guard rails.

7. The vibration device of claim 1, wherein the sliding apparatus comprises:
sliding panels being attached to upper portions or lower portions of both side surfaces of the main vibration body; and
rolling members being provided between the sliding panels and the inner surfaces of the external body.

8. The vibration device of claim 7, wherein the rolling members correspond to cylindrical bars or multiple circular rollers.

9. The vibration device of claim 7, wherein, in order to prevent the main vibration body from shaking back-and-forth and left-to-right inside the external body, a link member is rotatably installed between the external body and the main vibration member, and wherein the link member and the rolling member are respectively installed on an upper portion and a lower portion of the main vibration body, or vice versa.

10. The vibration device of claim 1, wherein a stopper is installed at an upper portion of the sliding apparatus in order to restrict descending movements of the main vibration body when performing descending movements.

11. The vibration device of claim 1, wherein a combination structure for attaching and detaching tools and equipments to and from the mounting bracket is configured of a combination of a latch unit and a pin.

12. The vibration device of claim 8, wherein, in order to prevent the main vibration body from shaking back-and-forth and left-to-right inside the external body, a link member is rotatably installed between the external body and the main vibration member, and wherein the link member and the rolling member are respectively installed on an upper portion and a lower portion of the main vibration body, or vice versa.

13. The vibration device of claim 2, wherein a stopper is installed at an upper portion of the sliding apparatus in order to restrict descending movements of the main vibration body when performing descending movements.

14. The vibration device of claim 3, wherein a stopper is installed at an upper portion of the sliding apparatus in order to restrict descending movements of the main vibration body when performing descending movements.

15. The vibration device of claim 4, wherein a stopper is installed at an upper portion of the sliding apparatus in order to restrict descending movements of the main vibration body when performing descending movements.

16. The vibration device of claim 5, wherein a stopper is installed at an upper portion of the sliding apparatus in order to restrict descending movements of the main vibration body when performing descending movements.

17. The vibration device of claim 6, wherein a stopper is installed at an upper portion of the sliding apparatus in order to restrict descending movements of the main vibration body when performing descending movements.

18. The vibration device of claim 7, wherein a stopper is installed at an upper portion of the sliding apparatus in order to restrict descending movements of the main vibration body when performing descending movements.

19. The vibration device of claim 8, wherein a stopper is installed at an upper portion of the sliding apparatus in order to restrict descending movements of the main vibration body when performing descending movements.
